(19) United States
(12) Patent Application Publication
(10) Pub. No.: US 2002/0027840 A1
(43) Pub. Date: Mar. 7, 2002

(54) Dynamic control diffraction grating, information read/write apparatus and information read apparatus

(76) Inventors: Ichiro Morishita, Yokohama (JP); Mitsuhiro Togashi, Yokohama (JP)

Correspondence Address: MORGAN, LEWIS & BOCKIUS, 1800 M STREET NW, WASHINGTON, DC, 20036-5869, US

(21) Appl. No.: 09/821,738

(22) Filed: Mar. 30, 2001

(30) Foreign Application Priority Data
Sep. 1, 2000 (JP) 2000-266251

(51) Int. Cl. G11B 7/095; G11B 7/135

(52) U.S. Cl. 369/44.23; 369/53.37; 369/44.38; 369/112.02

(57) ABSTRACT

A dynamic control diffraction grating for dynamically varying a light amount ratio of a zero-order diffracted beam of light to high-order diffracted beams of light. The dynamic control diffraction grating comprises a voltage-dependent phase varying material for transmitting a beam of light therethrough and varying the phase of the transmitted light beam in response to external voltages applied thereto, the voltages having different levels and being applied to the phase varying material at regular intervals in a comb form.

### BACKGROUND OF THE INVENTION

1. Field of the Invention

The present invention relates in general to a dynamic control diffraction grating, information read/write apparatus and information read apparatus, and more particularly to an optical information read/write apparatus and optical information read apparatus employing an optical disc as a recording medium, and a dynamic control diffraction grating used as a spectroscope in such an optical information read/write apparatus and optical information read apparatus.

2. Description of the Prior Art

FIG. 2 is a view schematically showing the construction of an optical system of an existing optical information read/write apparatus and optical information read apparatus. The optical information read/write apparatus is adapted to write information on an optical disc and read the written information from the disc, and the optical information read apparatus is adapted to only read the written information from the disc. The optical information read/write apparatus may be, for example, a CD-R, CD-RAM, DVD-RAM, MO, etc., and the optical information read apparatus may be, for example, a CD, CD-ROM, DVD, DVD-ROM, etc.

In FIG. 2, the reference numeral 10 denotes a laser diode (LD), 11 denotes a diffraction grating, 12 denotes a beam splitter, 13 denotes an object lens, 14 denotes an optical disc (recording medium), and 15 denotes a photodiode (PD). Also, a broken line indicates an optical axis of a main beam of light conducting the writing or reading of information.

For example, in the optical information read apparatus, the laser diode 10 emits a beam of laser light with a certain wavelength, which is then transmitted as a zero-order diffracted beam of light (main beam of light) to the beam splitter 12 through the diffraction grating 11. Thereafter, the zero-order diffracted beam of light is reflected by the beam splitter 12 and then projected on the optical disc 14 through the object lens 13.

A variety of information are stored on the optical disc 14 in the form of a pit arrangement. The main beam of light projected on the optical disc 14 is modulated according to the presence or not of a pit, reflected therefrom and then incident on the beam splitter 12 through the object lens 13. The incident beam of light is projected on the photodiode 15 through the beam splitter 12, which then converts the projected beam of light into an electrical signal varying in level with the presence or not of a pit, namely, a radio frequency (RF) signal indicative of a pit arrangement.

Notably, the diffraction grating 11 is provided to realize a three-beam method, which is one of optical disc tracking servo methods. This diffraction grating 11 obtains a first-order diffracted spectrum (+ first-order beam of light and − first-order beam of light) of two sub-beams of light provided for tracking servo of a pit. Namely, as shown in FIG. 3a, a zero-order diffracted beam of light (zero-order beam of light) among beams of laser light incident on the diffraction grating 11 is transmitted through the grating 11 as the main beam of light M. Also, the diffraction grating 11 outputs the + first-order beam of light (sub-beam of light A) and − first-order beam of light (sub-beam of light B) centering around the main light beam at certain angles to the main light beam.

For example, as shown in FIG. 3b, the main beam of light M is projected on a pit P on a main track Tm of the optical disc 14 from which information is to be read, and then forms a spot of light Sm thereon. On the other hand, the sub-beam of light A is projected on a position displaced from the track Tm toward one adjacent track T1 at a certain distance, and then forms a spot of light Sa thereon, and the sub-beam of light B is projected on a position displaced from the track Tm toward the other adjacent track T2 at a certain distance, and then forms a spot of light Sb thereon. With rotation of the optical disc 14, the respective light spots Sm, Sa and Sb sequentially move, for example, upward as indicated by an arrow with the lapse of time and are then projected on the respective pits arranged on the main track Tm.

With the movement of the light spot Sm, the main light beam M sequentially reads an arrangement of pits on the main track Tm. On the other hand, the light spot Sa and light spot Sb are positioned in such a manner that they are displaced at the same distance relative to the light spot Sm. In this regard, the light spot Sm of the main light beam M can travel on the main track Tm with no tracking error when reflected beams of light of the sub light beams A and B are equal in intensity. In other words, in the optical information read apparatus employing the three-beam method, the tracking servo for the optical disc 14 is performed to make the reflected beams of light of the sub light beams A and B equal in intensity.

The above-mentioned three-beam method is advantageous in that a stable servo characteristic is obtained and the cost is lower than other tracking servo methods such as a one-beam method. In this regard, the three-beam servo method is widely applied to the optical information read apparatus. However, the three-beam method has the following problems when it is applied to the optical information read/write apparatus.

That is, in the case where the diffraction grating 11 is used to obtain the spectrum of the main light beam M and the sub light beams A and B, a light amount ratio of the main light beam M to the sub light beams A and B is regularly determined according to an optical characteristic of the grating 11. For example, assuming that the total light amount of the main light beam M and the sub light beams A and B is 100 in the optical information read apparatus, the diffraction grating 11 is designed such that the light amount ratio of the main light beam M to the sub light beams A and B are A:M:B=15:70:15. In the case where the optical information read/write apparatus employs such a diffraction grating 11, the light amount ratio of the main light beam M to the sub light beams A and B are A:M:B=15:70:15 in a write mode as well as a read mode.

In this case, information which was previously written on the adjacent tracks T1 and T2 by the sub light beams A and B displaced from the main light beam M toward the tracks T1 and T2 may be partially erased by the sub light beam A or B, which is a so-called cross erase phenomenon. In order to settle this cross erase phenomenon, the diffraction grating 11 may be considered to be designed such that the light amount ratio of the sub light beams A and B are small. In this case, however, the light amounts of the sub light beams A and B reflected from the optical disc 14 become small in the read mode and an electrical signal (tracking error signal) indicative of a difference between the reflected beams of light thus becomes low in level. As a result, the tracking error signal is degraded in S/N ratio, thereby making it impossible to realize a stable tracking servo.

### SUMMARY OF THE INVENTION

Therefore, the present invention has been made in view of the above problems, and it is an object of the present invention to provide a diffraction grating (dynamic control diffraction grating) which is capable of dynamically varying a light amount ratio of a zero-order diffracted beam of light to high-order diffracted beams of light.

It is another object of the present invention to provide a dynamic control diffraction grating which is capable of dynamically switching high-order diffracted beams of light.

It is a further object of the present invention to provide an optical information read/write apparatus which is capable of realizing the optimum tracking servo in a read mode.

It is yet another object of the present invention to provide an optical information read apparatus which is capable of eliminating cross-talks from adjacent tracks.

In accordance with one aspect of the present invention, the above and other objects can be accomplished by the provision of a dynamic control diffraction grating comprising a voltage-dependent phase varying material for transmitting a beam of light therethrough and varying the phase of the transmitted light beam in response to external voltages applied thereto, the voltages having different levels and being applied to the phase varying material at regular intervals in a comb form.

In accordance with another aspect of the present invention, there is provided a dynamic control diffraction grating comprising a voltage-dependent phase varying material or transmitting a beam of light therethrough and varying the phase of the transmitted light beam in response to first and second voltages applied thereto; a first transparent electrode attached to one inner surface of a flat glass panel for applying the first voltage to the phase varying material, the glass panel containing the phase varying material, the first transparent electrode including a plurality of combs arranged at regular intervals; and a second transparent electrode attached to the other inner surface of the glass panel for applying the second voltage to the phase varying material, the second transparent electrode including a plurality of combs arranged at regular intervals.

Preferably, the voltage-dependent phase varying material may be liquid crystal.

As an alternative, the voltage-dependent phase varying material may be a refractive index varying material for varying the phase of the transmitted light beam with a variation in its refractive index responsive to the first and second voltages

More preferably, the refractive index varying material may be lithium niobate.

In accordance with a further aspect of the present invention, there is provided an information read/write apparatus using a three-beam method for separating a beam of light emitted from a light source into a main beam of light and two sub-beams of light, driving a tracking servo of the main light beam on a recording medium using the two sub light beams and performing read and write modes of the recording medium using the main beam, the apparatus comprising a dynamic control diffraction grating having a voltage-dependent phase quarrying material for transmitting the beam of light emitted from the light source therethrough and varying the phase of the transmitted light beam in response to first and second voltages applied thereto, thereby diffracting the transmitted light beam to generate the main beam of light and two sub-beams of light, the first and second voltages having different levels and being applied to the phase varying material at regular intervals in a comb form; and supply voltage setting means for setting the levels of the first and second voltages such that a light amount ratio of the main light beam to the sub light beams is greater in the write mode than the read mode.

In accordance with a further aspect of the present invention, there is provided an information read/write apparatus using a three-beam method for separating a beam of light emitted from a light source into a main beam of light and two sub-beams of light, driving a tracking servo of the main light beam on a recording medium using the two sub light beams and performing read and write modes of the recording medium using the main beam, the apparatus comprising a dynamic control diffraction grating for separating the beam of light emitted from the light source into the main beam of light and two sub-beams of light, the main light beam being a zero-order diffracted beam of light, the sub light beams being first-order diffracted beams of light, the dynamic control diffraction grating including a voltage-dependent phase varying material for transmitting the beam of light emitted from the light source therethrough and varying the phase of the transmitted light beam an response to first and second voltages applied thereto, a first transparent electrode attached to one inner surface of a flat glass panel for applying the first voltage to the phase varying material, the glass panel containing the phase varying material, the first transparent electrode including a plurality of combs arranged at regular intervals, and a second transparent electrode attached to the other inner surface of the glass panel for applying the second voltage to the phase varying material, the second transparent electrode including a plurality of combs arranged at regular intervals; and supply voltage setting means for setting the levels of the first and second voltages such that a light amount ratio of the main light beam to the sub light beams is greater in the write mode than the read mode.

In accordance with another aspect of the present invention, there is provided an information read/write apparatus for performing a tracking servo operation any read and write modes of a recording medium using a one-beam method, separating a beam of light emitted from a light source into a main beam of light and two sub-beams of light in the read mode, reading information from adjacent tracks of the recording medium using the two sub-beams of light, reading information from a main track of the recording medium using the main light beam and controlling crosstalks contained in the information read from the main track using the information read from, the adjacent tracks, the apparatus comprising a dynamic control diffraction grating having a voltage-dependent phase varying material for transmitting the beam of light emitted from the light source therethrough and varying the phase of the transmitted light beam in response to first and second voltages applied thereto, thereby diffracting the transmitted light beam to generate the main beam of light and two sub-beams of light, the first and second voltages having different levels and being applied to the phase varying material at regular intervals in a comb form; and supply voltage setting means for setting the levels of the first and second voltages such that the sub light beams cannot be generated in the write mode and can be generated in predetermined intensity ratios to the main beam in the read mode.

In accordance with another aspect of the present invention, there is provided an information read/write apparatus for performing a tracking servo operation and read and write modes of a recording medium using a one-beam method, separating a beam of light emitted from a light source into a main beam of light and two sub-beams of light in the read mode, reading information from adjacent tracks of the recording medium using the two sub-beams of light, reading information from a main track of the recording medium using the main light beam and controlling crosstalks contained in the information read from the main track using the information read from the adjacent tracks, the apparatus comprising a dynamic control diffraction crating for separating the beam of light emitted from the light source into the main beam of light and two sub-beams of light, the main light beam being a zero-order diffracted beam of light, the sub light beams being first-order diffracted beams of light, the dynamic control diffraction grating including a voltage-dependent phase varying material for transmitting the beam of light emitted from the light source therethrough and varying the phase of the transmitted light beam in response to first and second voltages applied thereto, a first transparent electrode attached to one inner surface of a flat glass panel for applying the first voltage to the phase varying material, the glass panel containing the phase varying material, the first transparent electrode including a plurality of combs arranged at regular intervals, and a second transparent electrode attached to the other inner surface of the glass panel for applying the second voltage to the phase varying material, the second transparent electrode including a plurality of combs arranged at regular intervals; and supply voltage setting means for setting the levels of the first and second voltages such that the sub light beams cannot be generated in the write mode and can be generated in predetermined intensity ratios to the main beam in the read mode.

Preferably, the voltage-dependent phase varying material may be liquid crystal.

More preferably, the voltage-dependent phase varying material may be lithium niobate.

In accordance with another aspect of the present invention, there is provided an information read apparatus for separating a beam of light emitted from a light source into a main beams of light and two sub-beams of light, reading information from adjacent tracks of a recording medium using the two sub-beams of light, reading information from a main track of the recording medium using the main light beam and controlling crosstalks contained in the information read from the main track using the information read from the adjacent tracks, the apparatus comprising a dynamic control diffraction grating having a voltage-dependent phase varying material for transmitting the beam of light emitted from the light source therethrough and varying the phase of the transmitted light beam in response to first and second voltages applied thereto, thereby diffracting the transmitted light beam to generate the main beam of light and two sub-beams of light, the first and second voltages having different levels and being applied to the phase varying material at regular intervals in a comb form; and supply voltage setting means for supplying the first and second voltages to the dynamic control diffraction grating.

In accordance with yet another aspect of the present invention, there is provided an information read apparatus for separating a beam of light emitted from a light source into a main beam of light and two sub-beams of light, reading information from adjacent tracks of a recording medium using the two sub-beams of light, reading information from a main track of the recording medium using the main light beam and controlling crosstalks contained in the information read from the main track using the information read from the adjacent tracks, the apparatus comprising a dynamic control diffraction grating for separating the beam of light emitted from the light source into the main beam of light and two sub-beams of light, the main light beam being a zero-order diffracted beam of light, the sub light beams being first-order diffracted beams of light, the dynamic control diffraction grating including a voltage-dependent phase varying material for transmitting the beam of light emitted from the light source therethrough and varying the phase of the transmitted light beam in response to first and second voltages applied thereto, a first transparent electrode attached to one inner surface of a flat glass panel for applying the first voltage to the phase varying material, the glass panel containing the phase varying material, the first transparent electrode including a plurality of combs arranged at regular intervals, and a second transparent electrode attached to the other inner surface of the glass panel for applying the second voltage to the phase varying material, the second transparent electrode including a plurality of combs arranged at regular intervals; and supply voltage setting means for supplying the first and second voltages to the dynamic control diffraction grating.

Preferably, the voltage-dependent phase varying material may be liquid crystal.

More preferably, the voltage-dependent phase varying material may be lithium niobate.

### BRIEF DESCRIPTION OF THE DRAWINGS

The above and other objects, features and advantages of the present invention will be more clearly understood from the following detailed description taken in conjunction with the accompanying drawings, in which:

FIG. 1a is a front view showing the construction of a dynamic control diffraction grating in accordance with a preferred embodiment of the present invention;

FIG. 1b is a side view the construction of the dynamic control diffraction grating in accordance with the preferred embodiment of the present invention;

FIG. 2 is a view schematically showing the construction of an optical system of an existing optical information read/write apparatus and optical information read apparatus employing an optical disc as a recording medium; and

FIGS. 3a and 3b are views illustrating the function of a diffraction grating in the existing optical information read/write apparatus and optical information read apparatus.

### DETAILED DESCRIPTION OF THE PREFERRED EMBODIMENTS

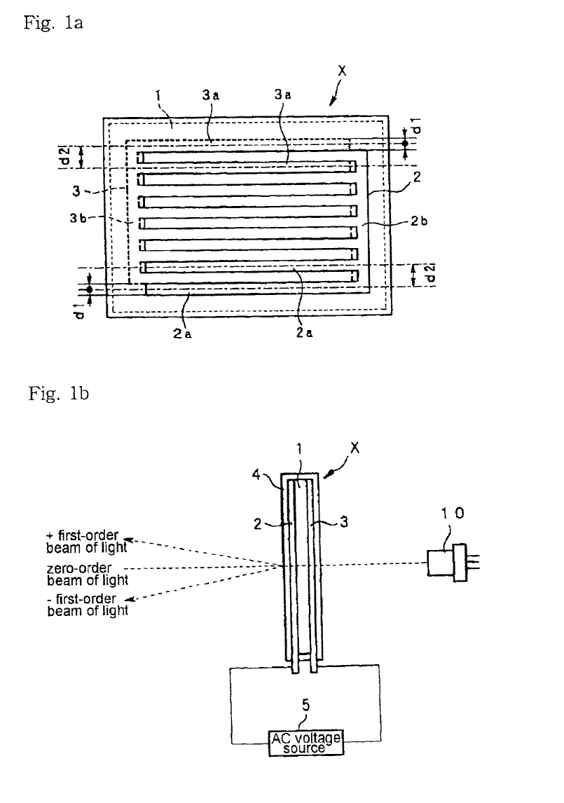

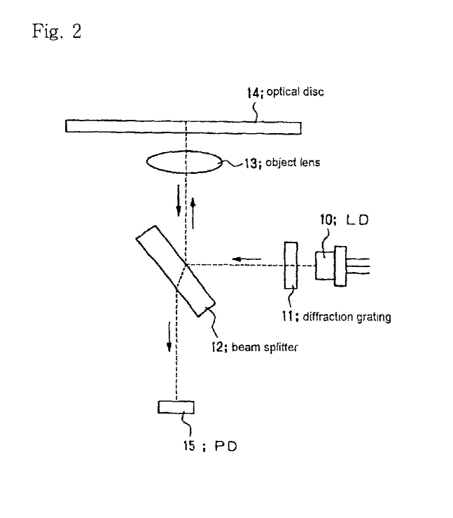

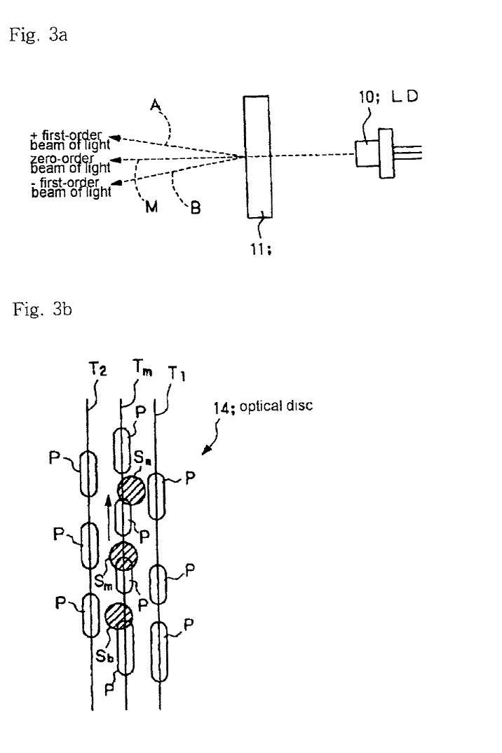

Hereinafter, the preferred embodiments of a dynamic control diffraction grating, information read/write apparatus and information read apparatus in accordance with the present invention will be described with reference to the accompanying drawings. Some parts in FIGS. 1a and 1b are the same as those in FIGS. 2 and 3. Therefore, the same parts are denoted by the same reference numerals and a description thereof will thus be omitted.

FIG. 1 shows the construction of a dynamic control diffraction grating in accordance with a preferred embodiment of the present invention, wherein FIG. 1a is a front view of the dynamic control diffraction grating and FIG. 1b is a side view of the diffraction grating. In these drawings, the reference numeral X denotes the dynamic control diffraction grating, 1 denotes a phase varying material, 2 denotes a comb-type transparent electrode (first transparent electrode), 3 is a comb-type transparent electrode (second transparent electrode), 4 denotes a glass panel, and 5 denotes an alternating current (AC) voltage source (supply voltage setting means).

The phase varying material 1 is a voltage-dependent optical material for transmitting a beam of light therethrough and varying the phase of the transmitted light beam in response to external voltages applied thereto. This material 1 may be, for example, a liquid crystal for varying the phase of the transmitted light beam with a variation in the orientation of its molecules responsive to the applied voltages, a refractive index varying material for varying the phase of the transmitted light beam with a variation in its refractive index responsive to the applied voltages, or the like.

The phase varying material 1 may preferably be lithium niobate (LiNbO₃) with an excellent response characteristic to the applied voltages if it is the refractive index varying material. More preferably, the liquid crystal may be used as the phase varying material 1 rather than the refractive annex varying material in consideration of cost. This phase varying material is enclosed in the flat glass panel 4, which has a flat shape of a certain thickness.

The comb-type transparent electrode (first transparent electrode) 2 is attached to one inner surface of the glass panel 4 to apply a voltage to the phase varying material 1 through interaction with the comb-type transparent electrode 3 (second transparent electrode). The comb-type transparent electrode 2 includes, as shown in FIG. 1a, a plurality of combs 2a arranged in parallel at regular widths d1 or regular intervals d2, and a connector 2b for connecting the ends of the combs 2a with one another. On the other hand, the comb-type transparent electrode 3 is attached to the other inner surface of the glass panel 4 to apply a voltage to the phase varying material 1 through interaction with the comb-type transparent electrode 2. Similarly to the comb-type transparent electrode 2, the comb-type transparent electrode 3 includes, as shown in FIG. 1a, a plurality of combs 3a arranged in parallel at regular widths d1 or regular intervals d2, and a connector 3b for connecting the ends of the combs 3a with one another.

The combs 2a in the transparent electrode 2 and the combs 3a in the transparent electrode 3 are arranged at the same widths d1 or the same intervals d2 and do not overlap each other. Namely, each of the combs 3a in the transparent electrode 3 is positioned between adjacent ones of the combs 2a in the transparent electrode 2. The interval d2 is an important parameter in defining a diffraction angle of a first-order beam of light in the dynamic control diffraction grating X.

The AC voltage source 5 is adapted to supply AC voltages having a certain frequency to the comb-type transparent electrode 2 and comb-type transparent electrode 3. The frequency of the AC voltages may be, for example, 1 KHz. The level E2 of the AC voltage supplied to the comb-type transparent electrode 2 and the level E3 of the AC voltage supplied to the comb-type transparent electrode 3 have predetermined values, respectively.

In the present embodiment, the construction of the optical information read/write apparatus and optical information read apparatus is the same as the conventional construction of FIG. 2, with the exception that the dynamic control diffraction grating X replaces the diffraction grating 11 and the AC voltage source 5 is additionally provided to supply voltages to the dynamic control diffraction grating X. Therefore, a description will be omitted of the construction of the optical information read/write apparatus and optical information read apparatus in accordance with the present embodiment.

Next, a description will be given of the operation of the dynamic control diffraction grating X with the above-stated construction, and the operation of the optical information read/write apparatus and optical information read apparatus employing the diffraction grating X.

In the present dynamic control diffraction grating X, each of the combs 3a in the transparent electrode 3 is positioned between adjacent ones of the combs 2a in the transparent electrode 2, as stated previously. The voltage-independent phase varying material 1 is contained between the comb-type transparent electrode 2 and the comb-type transparent electrode 3, and the AC voltages are supplied to the phase varying material 1 via the combs 2a and 3a. Ac electric fields of 1 KHz are generated in respective portions of the phase varying material 1 facing the combs 2a and 3a, according to the levels E2 and E3 of the AC voltages.

It is common that the phase varying material 1 has some phase delay elements. In this regard, the phase varying material 1 cannot sufficiently follow the varying speed of external AC electric fields. As a result, effective values of the levels E2 and E3 of the AC voltages are applied to the respective portions of the phase varying material 1 facing the combs 2a and 3a, owing to the phase delay elements

That is, provided that the level E2 of the AC voltage supplied to the comb-type transparent electrode 2 and the level E3 of the AC voltage supplied to the comb-type transparent electrode 3 are set to different values, electric fields generated in the combs 2a in the transparent electrode 2 and electric fields generated in the combs 3a in the transparent electrode 3 will become different in intensity As a result, the phase S2 of light beams transparent through the portions of the phase varying material 1 facing the combs 2a in the transparent electrode 2 becomes different from the phase S3 of light beams transmitted through the portions of the phase varying material 1 facing the combs 3a in the transparent electrode 3.

Accordingly, the transmitted beams of light are diffracted due to a difference between the phase S2 and the phase S3. In this case, the angle of diffraction of the first-order beams of light is determined depending on the interval d2 between the adjacent combs 3a, and the light amount ratio of the zero-order beam of light (zero-order diffracted beam of light) to the first-order beams of light can be set according to the effective value of the level E2 of the AC voltage supplied to the comb-type transparent electrode 2 and the effective value of the level E3 of the AC voltage supplied to the comb-type transparent electrode 3.

In the optical information read/write apparatus, the light amount ratio of the main light beam M to the sub light beams A and B can readily be changed in the read and write modes for the three-beam method-based tracking servo by replacing the conventional diffraction grating 11 with the present dynamic control diffraction grating X and adjusting the levels E2 and E3 of the AC voltages supplied from the AC voltage source 5 to the dynamic control diffraction grating X in the write mode of the optical disc 14 and the levels E2 and E3 of the AC voltages supplied from the AC voltage source 5 to the dynamic control diffraction grating X in the read mode of the optical disc 14, respectively.

In the case where the present dynamic control diffraction grating X is applied to the optical information read/write apparatus, the light amount ratio of the main light beam M to the sub light beams A and B can preferably be set to A:M:B=15:70:15 in the read mode. Also in the write mode, the light amount ratio of the main light beam M to the sub light beams A and B can preferably be set to A:M:B=1:98:1. This dynamic control of the light amount ratio enables the optimum tracking servo to be realized in either the write mode or read mode and a cross erase phenomenon to be prevented in the write mode.

Further, in the dynamic control diffraction grating X, no diffraction occurs by blocking the supply of the AC voltage from the AC voltage source 5 to the phase varying material 1 or equalizing the levels E2 and E3 of the AC voltages (E2=E3). In this connection, the AC voltage source 5 can turn on/off the generation of the sub light beams A and B. The dynamic switching between the one-beam method and the three-beam method can be performed in this manner. Therefore, in the optical information read/write apparatus, the tracking servo method can be switched by performing a push-pull operation for the three-beam method in the read mode and the one-beam method in the write mode using the dynamic switching manner.

Furthermore, in a CD-R, the optical information read/write apparatus must adjust the intensity of the main light beam in the write mode according to discs because recording films of the discs have different sensitivities depending on makers. The use of the three-beam method in the CD-R because of the need for the above adjustment makes it impossible to set the intensities of the sub light beams to the optimum values and thus difficult to obtain a stable tracking characteristic. However, the dynamic control of the light amount ratio of the main light beam M to the sub light beams A and B using the dynamic control diffraction grating X makes it possible to realize the stable tracking characteristic in the CD-R using the three-beam method.

Although the dynamic control diffraction grating X has been disclosed for application to the generation of the sub light beams A and B in the three-beam method, it is applicable to the removal of crosswalks in the optical information read/write apparatus or optical information read apparatus.

Preferably, the optical information read/write apparatus comprises a crosstalk canceler for performing a tracking servo operation and information read/write operations for a recording medium using a one-beam method, generating a main beam of light and two sub-beams of light in a read mode using a diffraction grating, reading information from adjacent tracks of the recording medium by projecting the two sub-beams of light on the adjacent tracks, and canceling crosstalks contained in information read from a main track of the recording medium by the main beam using the information read from the adjacent tracks by the sub light beams.

Preferably, the optical information read apparatus comprises a crosstalk canceler for generating a main beam of light and two sub-beams of light using a diffraction grating, reading information from adjacent tracks of a recording medium by projecting the two sub-beams of light on the adjacent tracks, and canceling crosstalks contained in information read from a main track of the recording medium by the main beam using the information read from the adjacent tracks by the sub light beams. Although not described in detail, the crosstalk canceler can reduce the crosstalks (the information of the adjacent tracks) contained in the information of the main track on the basis of a difference between the RF signal to the main light beam and the RF signals of the sub light beams.

In the optical information read/write apparatus comprising the crosstalk canceler, the dynamic control diffraction grating X of the present invention is provided instead of the conventional diffraction grating. This dynamic control diffraction grating X can dynamically switch between a one-beam method in a write mode and a three-beam method in a read mode, and set a light amount ratio of a main beam of light to two sub-beams of light to an optimum value in the read mode by adjusting the levels of supply voltages from the AC voltage source 5. Further, in the optical information reed apparatus comprising the crosstalk canceler, the dynamic control diffraction grating X of the present invention can set a light amount ratio of a main beam of light to two sub-beams of light to an optimum value by adjusting the levels of supply voltages (AC voltages) from the AC voltage source 5.

As apparent from the above description, according to the present invention, the dynamic control diffraction grating, information read/write apparatus and information read apparatus have the following effects.

According to this invention, the dynamic control diffraction grating comprises a voltage-dependent phase varying material for transmitting a beam of light therethrough and varying the phase of the transmitted light beam in response to external voltages applied thereto. The voltages have different levels and are applied to the phase varying material at regular intervals in a comb form. The phase of light beams transmitted through portions of the phase varying material applied with a voltage is different from that of light beams transmitted through portions of the phase varying material applied with no voltage. As a result, the transmitted beam of light is diffracted due to the phase difference, which depends on a difference between the levels of voltages applied to the phase varying material. Therefore, a light amount ratio of a zero-order diffracted beam of light to high-order diffracted beams of light can be dynamically varied by adjusting the voltage levels. If the voltage supply to the phase varying material is blocked, no diffraction occurs, thereby making it possible to dynamically switch high-order diffracted beams of light.

According to this invention, the dynamic control diffraction grating comprises a voltage-dependent phase varying material for transmitting a beam of light therethrough and varying the phase of the transmitted light beam in response to first and second voltages applied thereto; a first transparent electrode attached to one inner surface of a flat glass panel for applying the first voltage to the phase varying material, the glass panel containing the phase varying material, the first transparent electrode including a plurality of combs arranged at regular intervals; and a second transparent electrode attached to the other inner surface of the glass panel for applying the second voltage to the phase varying material, the second transparent electrode including a plurality of combs arranged at regular intervals. The voltages of different levels are applied to the first and second transparent electrodes. The phase of light beams transmitted through portions of the phase varying material, positioned between the combs, is different from that of light beams transmitted through other portions of the phase varying material. As a result, the transmitted beam of light is diffracted due to the phase difference, which depends on a difference between the levels of the voltages applied to the first and second transparent electrodes. Therefore, a light amount ratio of a zero-order diffracted beam of light to high-order diffracted beams of light can be dynamically varied by adjusting the voltage levels. If the voltage supply to the first and second transparent electrodes is blocked, no diffraction occurs, thereby making it possible to dynamically switch high-order diffracted beams of light.

According to this invention, the voltage-dependent phase varying material is liquid crystal, resulting in a reduction in cost.

According to this invention, the voltage-dependent phase varying material is a refractive index varying material for varying the phase of the transmitted light beam with a variation in its refractive index responsive to the first and second voltages. As a result, the phase of the transmitted beam of light can be controlled on the basis of a variation in refractive index.

According to this invention, the refractive index varying material is lithium niobate with an excellent response characteristic to the applied voltages.

According to this invention, there is provided an information read/write apparatus using a three-beam method for separating a beam of light emitted from a light source into a main beam of light and two sub-beams of light, driving a tracking servo of the main light beam on a recording medium using the two sub light beams and performing read and write modes of the recording medium using the main beam, the apparatus comprising a dynamic control diffraction grating having a voltage-dependent phase varying material for transmitting the beam of light emitted from the light source therethrough and varying the phase of the transmitted light beam in response to first and second voltages applied thereto, thereby diffracting the transmitted light beam to generate the main beam of light and two sub-beams of light, the first and second voltages having different levels and being applied to the phase varying material at regular intervals in a comb form; and supply voltage setting means for setting the levels of the first and second voltages such that a light amount ratio of the main light beam to the sub light beams is greater in the write mode than the read mode. This dynamic control of the light amount ratio enables the optimum tracking servo to be realized in either the write mode or read mode and a cross erase phenomenon to be prevented in the write mode.

According to the present invention, there is provided an information read/write apparatus using a three-beam method for separating a beam of light emitted from a light source into a main beam of light and two sub-beams of light, driving a tracking servo of the main light beam on a recording medium using the two sub light beams and performing read and write modes of the recording medium using the main beam, the apparatus comprising a dynamic control diffraction grating for separating the beam of light emitted from the light source into the main beam of light and two sub-beams of light, the main light beam being a zero-order diffracted beam of light, the sub light beams being first-order diffracted beams of light, the dynamic control diffraction grating including a voltage-dependent phase varying material for transmitting the beam of light emitted from the light source therethrough and varying the phase of the transmitted light beam in response to first and second voltages applied thereto, a first transparent electrode attached to one inner surface of a flat glass panel for applying the first voltage to the phase varying material, the glass panel containing the phase varying material, the first transparent electrode including a plurality of combs arranged at regular intervals, and a second transparent electrode attached to the other inner surface of the glass panel for applying the second voltage to the phase varying material, the second transparent electrode including a plurality of combs arranged at regular intervals; and supply voltage setting means for setting the levels of the first and second voltages such that a light amount ratio of the main light beam to the sub light beams is greater in the write mode than the read mode. This dynamic control of the light amount ratio enables the optimum tracking servo to be realized in either the write mode or read mode and a cross erase phenomenon to be prevented in the write mode.

According to the present invention, there is provided an information read/write apparatus for performing a tracking servo operation and read and write modes of a recording medium using a one-beam method, separating a beam of light emitted from a light source into a main beam of light and two sub-beams of light in the read mode, reading information from adjacent tracks of the recording medium using the two sub-beams of light, reading information from a main track of the recording medium using the main light beam and controlling crosstalks contained in the information read from the main track using the information read from the adjacent tracks, the apparatus comprising a dynamic control diffraction grating having a voltage-dependent phase varying material for transmitting the beam of light emitted from the light source therethrough and varying the phase of the transmitted light beam in response to first and second voltages applied thereto, thereby diffracting the transmitted light beam to generate the main beam of light and two sub-beams of light, the first and second voltages having different levels and being applied to the phase varying material at regular intervals in a comb form; and supply voltage setting means for setting the levels of the first and second voltages such that the sub light beams cannot be generated in the write mode and can be generated in predetermined intensity ratios to the main beam in the read mode. This dynamic control of the light amount ratio enables the optimum tracking servo to be realized in either the write mode or read mode and a cross erase phenomenon to be prevented in the write mode.

According to the present invention, there is provided an information read/write apparatus for performing a tracking servo operation and read and write modes of a recording medium using a one-beam method, separating a beam of light emitted from a light source into a main beam of light and two sub-beams of light in the read mode, reading information from adjacent tracks of the recording medium using the two sub-beams of light, reading information from a main track of the recording medium using the main light beam and controlling crosstalks contained in the information read from the main track using the information read from the adjacent tracks, the apparatus comprising a dynamic control diffraction grating for separating the beam of light emitted from the light source into the main beam of light and two sub-beams of light, the main light beam being a zero-order diffracted beam of light, the sub light beams being first-order diffracted beams of light, the dynamic control diffraction grating including a voltage-dependent phase varying material for transmitting the beam of light emitted from the light source therethrough and varying the phase of the transmitted light beam in response to first and second voltages applied thereto, a first transparent electrode attached to one inner surface of a flat glass panel for applying the first voltage to the phase varying material, the glass panel containing the phase varying material, the first transparent electrode including a plurality of combs arranged at regular intervals, and a second transparent electrode attached to the other inner surface of the glass panel for applying the second voltage to the phase varying material, the second transparent electrode including a plurality of combs arranged at regular intervals; and supply voltage setting means for setting the levels of the first and second voltages such that the sub light beams cannot be generated in the write mode and can be generated in predetermined intensity ratios to the main beam in the read mode.

According to the present invention, the voltage-dependent phase varying material is liquid crystal, resulting in a reduction in cost.

According to the present invention, the voltage-dependent phase varying material is lithium niobate with an excellent response characteristic to the applied voltages.

According to the present invention, there is provided an information read apparatus for separating a beam of light emitted from a light source into a main beam of light and two sub-beams of light, reading information from adjacent tracks or a recording medium using the two sub-beams of light, reading information from a main track of the recording medium using the main light beam and controlling crosstalks contained in the information read from the main track using the information read from the adjacent tracks, the apparatus comprising a dynamic control diffraction grating having a voltage-dependent phase varying material for transmitting the beam of light emitted from the light source therethrough and varying the phase of the transmitted light beam in response to first and second voltages applied thereto, thereby diffracting the transmitted light beam to generate the main beam of light and two sub-beams of light, the first and second voltages having different levels and being applied to the phase varying material at regular intervals in a comb form; and supply voltage setting means for supplying the first and second voltages to the dynamic control diffraction grating.

According to the present invention, there is provided an information read apparatus for separating a beam of light emitted from a light source into a main beam of light and two sub-beams of light, reading information from adjacent tracks of a recording medium using the two sub-beams of light, reading information from a main track of the recording medium using the main light beam and controlling crosstalks contained in the information read from the main track using the information read from the adjacent tracks, the apparatus comprising a dynamic control diffraction grating for separating the beam of light emitted from the light source into the main beam of light and two sub-beams of light, the main light beam being a zero-order diffracted beam of light, the sub light beams being first-order diffracted beams of light, the dynamic control diffraction grating including a voltage-dependent phase varying material for transmitting the beam of light emitted from the light source therethrough and varying the phase of the transmitted light beam in response to first and second voltages applied thereto, a first transparent electrode attached to one inner surface of a flat glass panel for applying the first voltage to the phase varying material, the glass panel containing the phase varying material, the first transparent electrode including a plurality of combs arranged at regular intervals, and a second transparent electrode attached to the other inner surface of the glass panel for applying the second voltage to the phase varying material, the second transparent electrode including a plurality of combs arranged at regular intervals; and supply voltage setting means for supplying the first and second voltages to the dynamic control diffraction grating.

According to the present invention, the voltage-dependent phase varying material is liquid crystal, resulting in a reduction in cost

According to the present invention, the voltage-dependent phase varying material is lithium niobate with an excellent response characteristic to the applied voltages.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A dynamic control diffraction grating comprising a voltage-dependent phase varying material for transmitting a beam of light therethrough and varying the phase of the transmitted light beam in response to external voltages applied thereto, said voltages having different levels and being applied to said phase varying material at regular intervals in a comb form.

2. A dynamic control diffraction grating as set forth in claim 1, wherein said voltage-dependent phase varying material is liquid crystal.

3. A dynamic control diffraction grating as set forth in claim 1, wherein said voltage-dependent phase varying material is a refractive index varying material for varying said phase of said transmitted light beam with a variation in its refractive index responsive to said first and second voltages.

4. A dynamic control diffraction grating as set forth in claim 3, wherein said refractive index varying material as lithium niobate.

5. A dynamic control diffraction grating comprising:
a voltage-dependent phase varying material for transmitting a beam of light therethrough and varying the phase of the transmitted light beam in response to first and second voltages applied thereto;
a first transparent electrode attached to one inner surface of a flat glass panel for applying said first voltage to said phase varying material, said glass panel containing said phase varying material, said first transparent electrode including a plurality of combs arranged at regular intervals; and
a second transparent electrode attached to the other inner surface of said glass panel for applying said second voltage to said phase varying material, said second transparent electrode including a plurality of combs arranged at regular intervals.

6. A dynamic control diffraction grating as set forth in claim 5, wherein said voltage-dependent phase varying material is liquid crystal.

7. A dynamic control diffraction grating as set forth in claim 5, wherein said voltage-dependent phase varying material is a refractive index varying material for varying said phase of said transmitted light beam with a variation in its refractive index responsive to said first and second voltages.

8. A dynamic control diffraction grating as set forth in claim 7, wherein said refractive index varying material is lithium niobate.

9. An information read/write apparatus using a three-beam method for separating a beam of light emitted from a light source into a main beam of light and two sub-beams or light, driving a tracking servo of said main light beam on a recording medium using said two sub light beams and performing read and write modes of said recording medium using said main beam, said apparatus comprising:
a dynamic control diffraction grating having a voltage-dependent phase varying material for transmitting said beam of light emitted from said light source therethrough and varying the phase of the transmitted light beam in response to first and second voltages applied thereto, thereby diffracting said transmitted light beam to generate said main beam of light and two sub-beams of light, said first and second voltages having different levels and being applied to said phase varying material at regular intervals in a comb form; and
supply voltage setting means for setting said levels of said first and second voltages such that a light amount ratio of said main light beam to said sub light beams is greater in said write mode than said read mode.

10. An information read/write apparatus as set forth in claim 9, wherein said voltage-dependent phase varying material is liquid crystal.

11. An information read/write apparatus as set forth in claim 9, wherein said voltage-dependent phase varying material is lithium niobate.

12. An information read/write apparatus using a three-beam method for separating a beam of light emitted from a light source into a main beam of light and two sub-beams of light, driving a tracking servo of said main light beam on a recording medium using said two sub light beams and performing read and write modes of said recording medium using said main beam, said apparatus comprising:
a dynamic control diffraction grating for separating said beam of light emitted from said light source into said main beam of light and two sub-beams of light, said main light beam being a zero-order diffracted beam of light, said sub light beams being first-order diffracted beams of light, said dynamic control diffraction grating including a voltage-dependent phase varying material for transmitting said beam of light emitted from said light source therethrough and varying the phase of the transmitted light beam in response to first and second voltages applied thereto, a first transparent electrode attached to one inner surface of a flat glass panel for applying said first voltage to said phase varying material, said glass panel containing said phase varying material, said first transparent electrode including a plurality of combs arranged at regular intervals, and a second transparent electrode attached to the other inner surface of said glass panel for applying said second voltage to said phase varying material, said second transparent electrode including a plurality of combs arranged at regular intervals; and
supply voltage setting means for setting said levels of said first and second voltages such that a light amount ratio of said main light beam to said sub light beams is greater in said write mode than said read mode.

13. An information read/write apparatus as set forth in claim 12, wherein said voltage-dependent phase varying material is liquid crystal.

14. An information read/write apparatus as set forth in claim 12, wherein said voltage-dependent phase varying material is lithium niobate.

15. An information read/write apparatus for performing a tracking servo operation and read and write nodes of a recording medium using a one-beam method, separating a beam of light emitted from a light source into a main beam of light and two sub-beams of light in said read mode, reading information from adjacent tracks of said recording medium using said two sub-beams of light, reading information from a main track of said recording medium using said main light beam and controlling crosstalks contained in said information read from said main track using said information read from said adjacent tracks, said apparatus comprising:
a dynamic control diffraction grating having a voltage-dependent phase varying material for transmitting said beam of light emitted from said light source therethrough and varying the phase of the transmitted light beam in response to first and second voltages applied thereto, thereby diffracting said transmitted light beam to generate said main beam of light and two sub-beams of light, said first and second voltages having different levels and being applied to said phase varying material at regular intervals in a comb form; and
supply voltage setting means for setting said levels of said first and second voltages such that said sub light beams cannot be generated in said write mode and can be generated in predetermined intensity ratios to said main beam in said read mode.

16. An information read/write apparatus as set forth in claim 15, wherein said voltage-dependent phase varying material is liquid crystal.

17. An information read/write apparatus as set forth in claim 15, wherein said voltage-dependent phase varying material is lithium niobate.

18. An information read/write apparatus for performing a tracking servo operation and read and write modes of a recording medium using a one-beam method, separating a beam of light emitted from a light source into a main beam of light and two sub-beams of light in said read mode, reading information from adjacent tracks of said recording medium using said two sub-beams of light, reading information from a main track of said recording medium using said main light beam and controlling crosstalks contained in said information read from said main track using said information read from said adjacent tracks, said apparatus comprising:
a dynamic control diffraction grating for separating said beam of light emitted from said light source into said main beam of light and two sub-beams of light, said main light beam being a zero-order diffracted beam of light, said sub light beams being first-order diffracted beams of light, said dynamic control diffraction grating including a voltage-dependent phase varying material for transmitting said beam of light emitted from said light source therethrough and varying the phase of the transmitted light beam in response to first and second voltages applied thereto, a first transparent electrode attached to one inner surface of a flat glass panel for applying said first voltage to said phase varying material, said glass panel containing said phase varying material, said first transparent electrode including a plurality of combs arranged at regular intervals, and a second transparent electrode attached to the other inner surface of said glass panel for applying said second voltage to said phase varying material, said second transparent electrode including a plurality of combs arranged at regular intervals; and
supply voltage setting means for setting said levels of said first and second voltages such that said sub light beams cannot be generated in said write mode and can be generated in predetermined intensity ratios to said main beam in said read mode.

19. An information read/write apparatus as set forth in claim 18, wherein said voltage-dependent phase varying material is liquid crystal.

20. An information read/write apparatus as set forth in claim 18, wherein said voltage-dependent phase varying material is lithium niobate.

21. An information read apparatus for separating a beam of light emitted from a light source into a main beam of light and two sub-beams of light, reading information from adjacent tracks of a recording medium using said two sub-beams of light, reading information from a main track of said recording medium using said main light beam and controlling crosstalks contained in said information read from said main track using said information read from said adjacent traces, said apparatus comprising:
a dynamic control diffraction grating having a voltage-dependent phase varying material for transmitting said beam of light emitted from said light source therethrough and varying the phase of the transmitted light beam in response to first and second voltages applied thereto, thereby diffracting said transmitted light beam to generate said main beam of light and two sub-beams of light, said first and second voltages having different levels and being applied to said phase varying material at regular intervals in a comb form; and
supply voltage setting means for supplying said first and second voltages to said dynamic control diffraction grating.

22. An information read apparatus as set forth in claim 21, wherein said voltage-dependent phase varying material is liquid crystal.

23. An information read apparatus as set forth in claim 21, wherein said voltage-dependent phase varying material is lithium niobate.

24. An information read apparatus for separating a beam of light emitted from a light source into a main beam of light and two sub-beams of light, reading information from adjacent tracks of a recording medium using said two sub-beams of light, reading information from a main track of said recording medium using said main light beam and controlling crosstalks contained in said information read from said main track using said information read from said adjacent tracks, said apparatus comprising:
a dynamic control diffraction grating for separating said beam of light, emitted from said light source into said main beam of light and two sub-beams of light, said main light beam being a zero-order diffracted beam of light, said sub light beams being first-order diffracted beams of light, said dynamic control diffraction grating including a voltage-dependent phase varying material for transmitting said beam of light emitted from said light source therethrough and varying the phase of the transmitted light beam in response to first and second voltages applied thereto, a first transparent electrode attached to one inner surface of a flat glass panel for applying said first voltage to said phase varying material, said glass panel containing said phase varying material, said first transparent electrode including a plurality of combs arranged at regular intervals, and a second transparent electrode attached to the other inner surface of said glass panel for applying said second voltage to said phase varying material, said second transparent electrode including a plurality of combs arranged at regular intervals, and
supply voltage setting means for supplying said first and second voltages to said dynamic control diffraction grating.

25. An information read apparatus as set forth in claim 24, wherein said voltage-dependent phase varying material is liquid crystal.

26. An information read apparatus as set forth in claim 24, wherein said voltage-dependent phase varying material is lithium niobate.
